(19) United States
(12) Patent Application Publication
(10) Pub. No.: US 2008/0118049 A1
(43) Pub. Date: May 22, 2008

(54) Local-smart-routing enabled auto dialer

(76) Inventor: Kap Suck Chang, Northbrook, IL (US)

Correspondence Address: LADAS & PARRY LLP, 224 SOUTH MICHIGAN AVENUE, SUITE 1600, CHICAGO, IL, 60604, US

(21) Appl. No.: 11/602,022

(22) Filed: Nov. 20, 2006

(51) Int. Cl. H04M 7/00

(52) U.S. Cl. 379/221.13

(57) ABSTRACT

A telephone connection is routed to either a local calling service provider's network or a designated carrier's network. Each digit of a telephone number dialed are received and stored. While each digit is being received, whether the telephone number is inside a predetermined calling area is determined based on the number of digits received. When the telephone number is determined as not being inside a predetermined calling area, connection to a designated carrier's network is established. If inside a predetermined calling area, connection to a local calling service provider's network is established. A searchable database is maintained to retain telephone number pattern fields and instruction fields associated with the telephone number pattern fields. The searchable database is searched one digit at a time sequentially for received digits until a telephone number pattern field matching the number of received digits is found, unless all digits dialed have been searched in the searchable database.

### BACKGROUND OF THE INVENTION

1. Field of the Invention

This application relates generally to an autodialer and more particularly to a smart autodialer that enables routing of connections to the local calling service provider's network or a designated carrier's network in a cost effective manner.

2. Description of the Prior Art

In the United States, the majority infrastructure for telephone services such as the telephone lines and the local telephone service switches, which are the communication nodes for these telephone lines, etc. are currently being provided by four major companies known as incumbent local exchange carriers (ILECs). The current four major ILEC are: SBC covering generally the Midwest region and California; QWEST covering generally the Northwestern Rocky Mountain states; Bellsouth covering generally the southern region including Texas and Georgia; and Verizon covering generally the East Coast region including New York and New Jersey. These ILECs came to existence as a result of the AT&T break-up that divided AT&T into many regional bell operating companies (RBOCs, a.k.a. “Babay Bells”) and GTE and many ILECs.

Another type of telephone companies known as competitive local exchange carrier (CLEC) competes with other telephone companies including the already established ILECs and CLECs in the United States. CLEC therefore refers to the telecommunications provider companies that compete with each other and with the other already established carriers (generally the ILEC). ILEC and CLEC are often referred to collectively as LEC

There are various types of telephone service providers, one of which being ILEC, and other types including CLEC, a inter-exchange carrier (IXC), a calling card service provider, a Voice over Internet protocol (VoIP) service provider, etc. An IXC is a legal and regulatory term for a telecommunications company, commonly called a long-distance telephone company such as AT&T, MCI, and Sprint in the United States. It is defined as the carriers, which provide inter local access and transport area (LATA) communication. A VoIP or broadband telephony routes voice conversations over the Internet or through any other IP-based network. A VoIP company is a company that can provide telephone services using VoIP technology.

Although the majority of the telephone infrastructure is controlled and operated by the several major ILECs, the laws allow other non-ILEC telephone service providers to compete with ILECs in providing telephone services to consumers by requiring the ILECs to provide the services of the infrastructure they own to other service providers at a price or a reasonable price set by the law or an appropriate regulatory government agency or other pertinent rules such as from the court.

Generally, a so-called “local” telephone calls are provided to consumers at a very low usage fee (which is almost free if not entirely free) whether the “local” telephone service is provide by a CLEC or a ILEC. A local call generally refers to any calls using a single switching facility and/or to any call that is originated, transferred, and terminated in the same local calling area. Alternatively, a local calling area refers to a calling area, in which the local calls are originated, transferred, and terminated. A local calling area is usually decided by the physical distance from the caller's location; however, the extent of the local calling area may vary based on the ILECs, states, etc. The charge for the local calls from ILECs is usually very low or even free to CLECs as oppose to charges for the non-local calls.

ILEC provides the local call service at a very low or nominal usage charge even to a competing CLEC, who does not have its own telephone lines or switches or other physical infrastructure structure but instead relies on the ILEC of its chose to make the local call connections for its customers.

Generally, as shown in FIG. 1, a local calling area 100 includes one or more local telephone switches 102 and the telephone lines 104, 106, 108 that are provided by a local telephone service provider, which is likely to be one of the current four major ILECs. Even though an ILEC is described as being the local telephone service provider, in theory, any LEC, IXC, VoIP company, or a calling card company can be a local telephone service provider so long as the company can provide a local telephone service to its customers.

Many telephone users 110, 112, 114 are connected to the ILEC's local telephone service switch 102 in the local calling area 100 via the telephone lines 104, 106, 108. The ILEC local telephone service provider typically sets a distance limit between a caller 110 and each of the receiver 112 or 114 (that is the distance between 110 and 112; and between 110 and 114) and if that distance is less than the specific distance already predetermined (such as 15 miles set by SBC in Illinois), all calls made by the caller 110 to all receivers 112, 114 that are connected to the same switch 102 are considered as local calling, and thus all areas covering the caller 110 and the receivers 112 and 114 are referred to as the local calling area 100. The ILEC local telephone service providers typically provide the local calling services free of charge to its own customers. In case of non-ILEC service provides (such as CLECs) who compete with the ILECs, the ILECs provide the local calling services to the non-ILEC service providers substantially free of charge. This allows the non-ILEC service providers to also provide the local calling service basically free of charge to its customers, even though the non-ILEC service providers are relying on the telephone infrastructure owned and operated by the ILEC local service providers.

Outside the local calling area, now referring to FIG. 2, the ILEC service providers charge at a predetermined rate per specified time unit (usually per minute) depending on the type of the long distance call. For example, a telephone call can be categorized into an extended local calling or a long distance calling or an international calling depending on the distance, which is set by the ILEC, between, for example, the caller 216 and the switch 208 of the receiver 218 or the distance between, for example, the caller 216 and the receiver 218.

An ILEC operates numerous local calling areas in its telephone service territory. Thus, a caller 216 may call a extended local call or a long stance call from the local area A via the line 212 connected to the switch 206, which is in turn connected to the switch 208, to the receiver 216 connected to the switch 208 via the line 214. It could be that both the local area A 202 of the caller and the local area 204 of the receiver may be operated by the same ILEC (e.g., SBC) or they are operated by two different ILECs (SBC and QWEST).

Whether or not the different local areas are operated by the same ILEC or different LECs, the telephone service consumers can choose the service provider that provides the non-local calling telephone services. Non-local calls refer to all telephone calls that are not considered local calls, such as local toll calls, local extended calls, long distance calls, and international calls. Local toll calls are the calls in between local calling areas and long distance areas. Sometimes, it could be called differently like local extended calls based on carriers and area. For example, a telephone service consumer may choose QWEST or other ILECs, or IXC as the designated carrier for connecting the switches 206 and 208, even if the switches 206, 208 are both owned and operated by SBC. If a telephone service consumer chooses a CLEC for its long distance telephone needs, the CLEC chooses an appropriate ILEC for connecting the switches 206 and 208 and then passes the ILEC charges with added profit to the consumer.

For example, in FIG. 1, the caller 110 can choose to be a customer of a CLEC, instead of the ILEC that owns and operates the local calling area 100. In this case, when the caller 110 initiates a telephone call, the CLEC is notified by the ILEC's switch 102 for billing purposes although all physical routing and steps required for the local calling between 110 and 114 are handled by the ILEC. The ILEC will in turn charge CLEC for its local calling services, which is a very nominal charge equivalent to substantially free. The CLEC can therefore compete by providing the local calling service to its customers in the local calling area 100 basically for free of charge.

For example, in FIG. 2, the caller 216 can choose to be a customer of a CLEC, instead of the ILEC that owns and operates the local area A, 202, or IXC or the ILEC (that is, a designated carrier) that is designated to handle the long distance or the international calling between the local areas A and B, 202, 204. The CLEC may discern that the intended call between the caller 216 and the receiver 218 is not a local calling. The CLEC may in turn select the designated carrier of its choice, who will provide the long distance calling service via the line 210 at a prearranged competitive price.

The local calling areas vary depending on the geographical region. For example, the distance for local calling is set for 7 miles or less between a caller and a receiver in the highly populated New York City. In certain parts of Illinois served by SBC, a local calling area defined by the 15 mile distance between a caller and any of the receivers, whereas in certain parts of California served by the same SBC, the distance for local calling is set for 12 miles between a caller and a receiver.

Thus, for example, for a call in the 12-15 mile radius region between a caller and a receiver in Illinois would be considered a local calling that will incur none or substantially none calling charges by the ILEC to CLEC. However, a call in the 12-15 mile radius region between a caller and a receiver in California would be considered a long distance incurring undesired calling charges by the ILEC to CLEC. Thus, knowing exactly which call between a caller and a receiver is considered a local call or not in a particular geographical region would be very advantageous to a CLEC or any non-ILEC telephone service operators.

### SUMMARY OF THE INVENTION

Against this backdrop, embodiments of the present invention have been developed.

A telephone connection is routed to either a local calling service provider's network or a designated carrier's network. To accomplish this smart routing, each digit of a telephone number as the digits are dialed by a user is received and stored. While each digit is being received, it determined as to whether the telephone number is inside a predetermined calling area based on the number of digits received. When the telephone number is determined as not being inside a predetermined calling area, connection to a designated carrier's network is established while each digit is being received. When the telephone number is determined as being inside a predetermined calling area, connection to a local calling service provider's network is established. The act of establishing connection to a designated carrier's network while each digit is being received and saved is performed transparently to the user without producing substantially audible sound or dial tone to the user.

The predetermined calling area is adjustable based on one of at least: a local calling area; LATA; a plurality of telephone numbers in one or more states in the United States; and all telephone number in the United States. The act of determining whether the telephone number is inside a predetermined calling area based on the already received number of digits while each digit is being received. A searchable database is maintained. The searchable database includes, inter alia, a plurality of telephone number pattern fields corresponding to a plurality of telephone numbers in a predetermined calling area; and a plurality of instruction fields, at least one of which instruction field is associated with each telephone number field. The searchable database is searched one digit at a time sequentially for one or more number of received digits until a telephone number pattern field matching the one or more number of received digits are found in the plurality of telephone number pattern fields, unless all digits of a telephone number dialed by the user have been searched in the searchable database.

When no matching telephone pattern field is found in the searchable database after searching all digits of a telephone number dialed by the user, the telephone dialed by the user is connected to a predetermined network of either a local calling service provider or a designated carrier. When no matching telephone pattern field is found in the searchable database after searching all digits of a telephone number dialed by the user, the telephone number is associated with a default instruction field predefined in the searchable database such that the default instruction field contain decision for connecting to either the local service provider's network or the designated carrier's network. When a matching telephone pattern field matching the one or more number of received digits is found in the searchable database, determining whether the telephone number dialed by the user is inside or outside a predetermined calling area based on the instruction field associated with the matching telephone number pattern field.

The act of establishing connection to a designated carrier's network while each digit is being received and the act of establishing connection to a local calling service provider's network are performed transparently to the user without producing substantially audible sound or dial tone or DTMF tone to the user. The act of establishing connection to a designated carrier's network comprises autodialing a number of digits required by the designated carrier for connection to the designated carrier's network. The number of digits required by the designated carrier for connection to the designated carrier's network comprise one or both of an access number and a PIN number, and wherein the autodialing of one or both of the access number or the PIN number occur without producing substantially audible sound or dial tone to the user. Entering PIN process could be eliminated by using caller's Caller ID.

All received digits of the telephone number dialed by the user are transferred to the designated carrier's network after establishing the connection with the designated carrier's network and transferring any additional digits dialed by the user after having established the connection with the designated carrier's network without producing substantially audible sound or dial tone or DTMF tone to the user.

The telephone number pattern field of the searchable database comprise one or more number of digits representing one of at least: a short key; an access number; a PIN number; an international dialing prefix (IDP); a circuit identification code (CIC); a service code; NPA-NXX of a telephone number in the predetermined calling area.

A smart autodialer routes a telephone connection to either a local calling service provider's network or a designated carrier's network. The smart autodialer has at least a first port, second port, a storage unit, a process unit, and a searchable database. The first port is connectable to a telecommunication device including a telephone. The second port is connectable to a outside telephone network. The storage unit receives and stores each digit of a telephone number as the digits are dialed by a user and inputted to the first port. A process unit determines whether the telephone number being dialed by the user is inside a predetermined calling area based on the number of digits received. When the telephone number is determined as not being inside a predetermined calling area, connection to a designated carrier's network is established while each digit is being received. When the telephone number is determined as being inside a predetermined calling area, connection to a local calling service provider's network is established. The searchable database include at least a plurality of telephone number pattern fields and a plurality of instruction fields. A plurality of telephone number pattern fields correspond to a plurality of telephone numbers in a predetermined calling area. At least one of the plurality of instruction fields is associated with each telephone number pattern field. The searchable data base is searched one digit at a time sequentially for one or more number of received digits until a telephone number pattern field matching the one or more number of received digits are found in the plurality of telephone number pattern fields, unless all digits of a telephone number dialed by the user have been searched in the searchable database.

These and various other features as well as advantages which characterize the present invention will be apparent from a reading of the following detailed description and a review of the associated drawings.

### BRIEF DESCRIPTION OF THE DRAWINGS

FIG. 1 shows an example of a conventional local calling area.

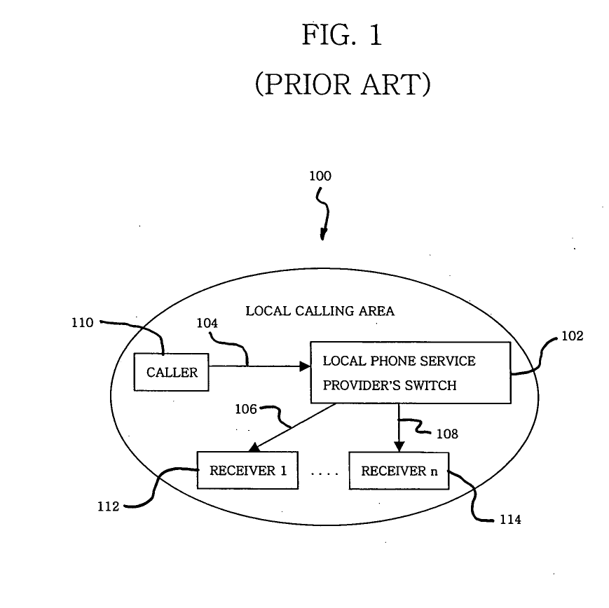

FIG. 2 shows an example of a conventional telephone service structure between two local calling area.

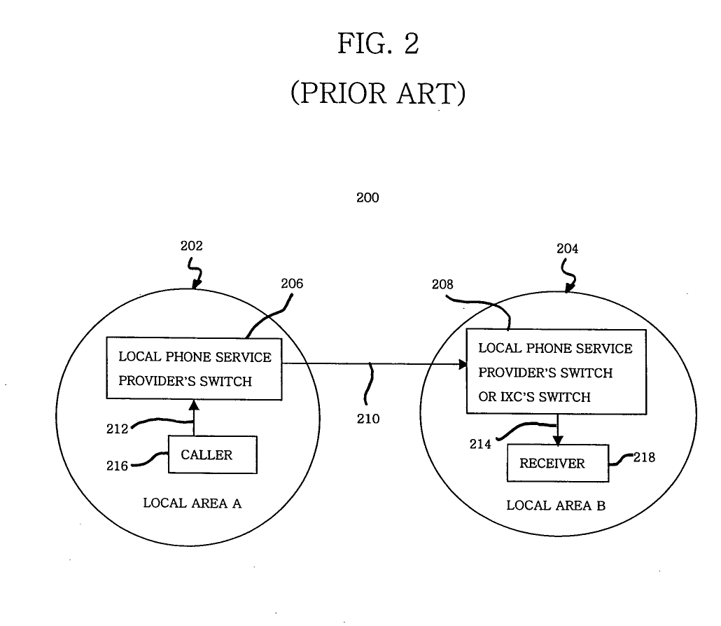

FIG. 3 is shows an LSREA Dialer of an embodiment of the present invention in the context of multiple local areas interconnected by a communications network.

FIG. 4 is a process flow diagram for showing the technique for connecting to a designated carrier's network performed by a LSREA Dialer according to an embodiment of the present invention.

FIG. 5 is a process flow diagram for showing the overview of the routing technique performed by a LSREA Dialer according to an embodiment of the present invention.

FIG. 6 is a process flow diagram for illustrating steps taken in using a calling card to place a telephone call.

FIG. 7 is a process flow diagram for illustrating steps taken in using an auto dialer to place a telephone call.

FIG. 8 is a process flow diagram for showing the smart routing and autodialing techniques performed by the LSREA Dialer according to an embodiment of the present invention.

FIG. 9A-9D show different set up configurations according to which the LSREA Dialer as disclosed in accordance with an embodiment of the present invention may be arranged with telecommunication devices and networks.

### DETAILED DESCRIPTION

One of the ways for a local telephone service provider (such as ILEC, CLEC, IXC, calling card service provider, and VoIP service provider) to save the cost is using a local telephone service provider's public switched telephone network (PSTN) for local calls and using a designated carrier's network for all other calls that are not considered local calls. PSTN is a traditional communication system (or network) as opposed to VoIP network that is available for public to allow users to interconnect communication devices.

The present invention is directed to, inter alia, an auto-dialer type of the equipment that can route all non-local calls to the designated carrier's network while all local calls are routed to the local telephone service provider's switch. Here, the definition of a local call is defined by the local telephone service provider, and generally cover an area that the ILEC in the coverage area charge the local calling for free or substantially free or substantially low or competitive price acceptable by the local telephone service provider.

Further, the present invention is directed to, inter alia, a user interface that is not recognized by a caller while the local and other non-local calls are routed to the designated carrier's network through a “Local-Smart-Routing Enabled Auto Dialer” (hereinafter “the LSREA Dialer”) according to an embodiment of the present invention. The LSREA Dialer is an auto-dialer type of equipment, which has a local call smart routing table (LCSR Table). It can route the local calls to ILEC network and the non-local calls to the designated carrier's network. The user interface is the aggregate of means by which people (the users) interact with a particular machine, device, computer program or other complex tool (the system). The user interface provides means of: input which allows the users to manipulate the system and output which allows the system to produce the effects of the users' manipulation.

A LCSR Table is used for a database embedded in the LSREA Dialer. It has NPA-NXX database for a Local Calling Area. It is used to compare NPA-NXX of the destination telephone number with the database to recognize whether the number is a local call or a non-local call. A LCSR Table has instruction fields associated with the telephone number pattern field. The instructions in the LCSR instruction fields show the LSREA Dialer the way to act based on the value of the telephone number pattern in LCSR Table.

A LSREA Dialer according to an embodiment of the present invention can sort the destination telephone numbers by the call type and determine whether the call which would be provided substantially free by the ILEC or a non-local call which would not be provided substantially free by the ILEC. If the destination telephone number is a local call, the LSREA Dialer transfers the call to the ILEC's switch to take advantage of the substantially free service. If the destination telephone number is sorted into a non-local call, the LSREA Dialer will transfer the call to the designated carrier's network that is chosen by the CLEC operating the LSREA Dialer. The designated carrier chosen by CLEC operating the LSREA Dialer may be a different ILEC than the ILEC providing the local call service to the CLEC. In this manner, all local calls will be routed to the ILEC operating in that local service area to take advantage of the substantially free service, but no non-local calls will be routed to the same ILEC operating the local service network if there were other ILECs or carriers providing the non-local telephone service at a lower rate.

For example, SBC (an ILEC) covers both the Chicago and Los Angeles areas. SBC defines the local service area in the Chicago area as approximately 15 mile radius from the location of the originating call; whereas, SBC defines the local service area in the Los Angeles area as approximately 7 mile radius from the originating call. A CLEC competing with SBC may nonetheless enter into a contractual agreement with SBC for the local telephone services at one coverage area (whether it be 15 mile radius, 12 mile radius, 7 mile radius, etc.). Thus, if a 15 mile radius is agreed to be a local calling service area between a CLEC and SBC, SBC will charge CLEC basically free for all local calls made in the Chicago area between 7 to 15 mile radius from the originating call. However, SBC will charge a higher usage fee to CLEC for all calls made in the Los Angeles area between 7 to 15 miles radius from the originating call. In this situation, it would be very advantageous to a CLEC using SBC for local calling service, if it can readily detect that a destination telephone number for a call originating in the Los Angeles area is inside or outside the 7 mile radius from the originating call to determine the local or non-local calling status. If it is outside the 7 mile radius, the CLEC may utilize service of another ILEC such as QWEST, if that carrier offers the non-local telephone service at a lower price than SBC.

Thus, the LSREA Dialer according to an embodiment of the present invention enables the telephone service providers, especially the CLECs, to route telephone calls based on the call types (i.e., local or non-local) at relatively lower price. In the same manner, the LSREA Dialer according to an embodiment of the present invention enables a caller, who is benefited by a CLEC utilizing the LSREA Dialer, to make non-local calls such as the local toll calls, long distance calls, international calls at relatively lower price as the CLEC can successfully shop for carriers that provide competitively lower service prices.

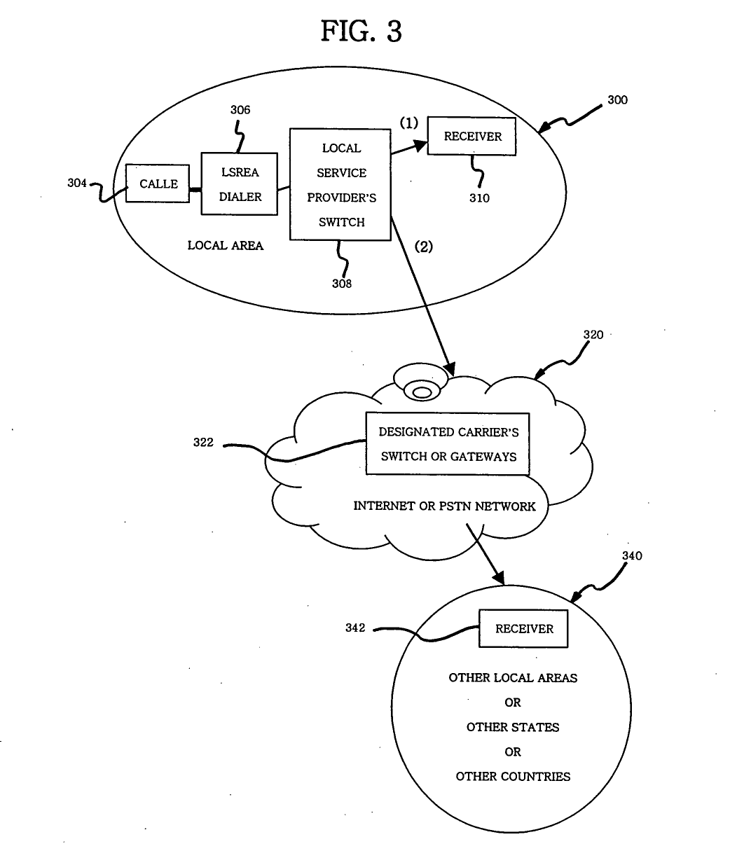

FIG. 3 shows one configuration for routing the local call and all other non-local calls to the designated carrier's network by utilizing the LSREA Dialer in accordance with an embodiment of the present invention.

A local service area 300 is a local telephone service area defined by the local service provider (usually an ILEC such as SBC, QWEST, etc.) who owns the telephone infrastructure in the local service area 300 including the switch 308. The local service area is defined as the area in which the local service provider is providing the calls for free or at a substantially free price or at a relatively low price determined by a competing service provider such as a CLEC. Similarly, the local call refers to any call made in the local service area for which the local service provider is providing the calls for free or at a substantially free price or at a relatively low price determined by a competing service provider such as a CLEC.

When a caller 304 makes a telephone call to a receiver 310, the LSREA Dialer 306 will first determine whether the call between the caller 304 and the receiver 310 is within the local service area as defined above. If the telephone call is determined to be the local call, the LSREA Dialer 306 according to an embodiment of the present invention will route the call through the local service provider's switch 308 to connect to the receiver 310 (see “(1)” in FIG. 3).

If on the other hand the LSREA Dialer determines that the call between the caller 304 and the receiver 342 is not a local call, the LSREA Dialer may route the call to the designated carrier's switch 322 in the telephone network 320 if the designated carrier of the switch 322 offers the non-local call “(2)” at a lower price than the local service provider providing the local service “(1).” The telephone network 320 for non-local calls is not just limited to the public switched telephone network (PSTN) but also include the Internet (such as VoIP) or other forms of communications network. The telephone network 320 will then terminate the call to the switch (not shown) operated by the operator of the local service area 340 and make the final connection to the receiver 342.

The user interface and/or operations for the LSREA Dialer 306 is designed such that it is almost impossible for a caller 304 to readily recognize when making the telephone calls whether the LSREA Dialer 306 is operating to route the local calls (e.g., the caller 304 is placing calls to the receiver 310) versus the non-local calls (e.g., the caller 304 is placing calls to the receiver 342) via different telephone service carriers.

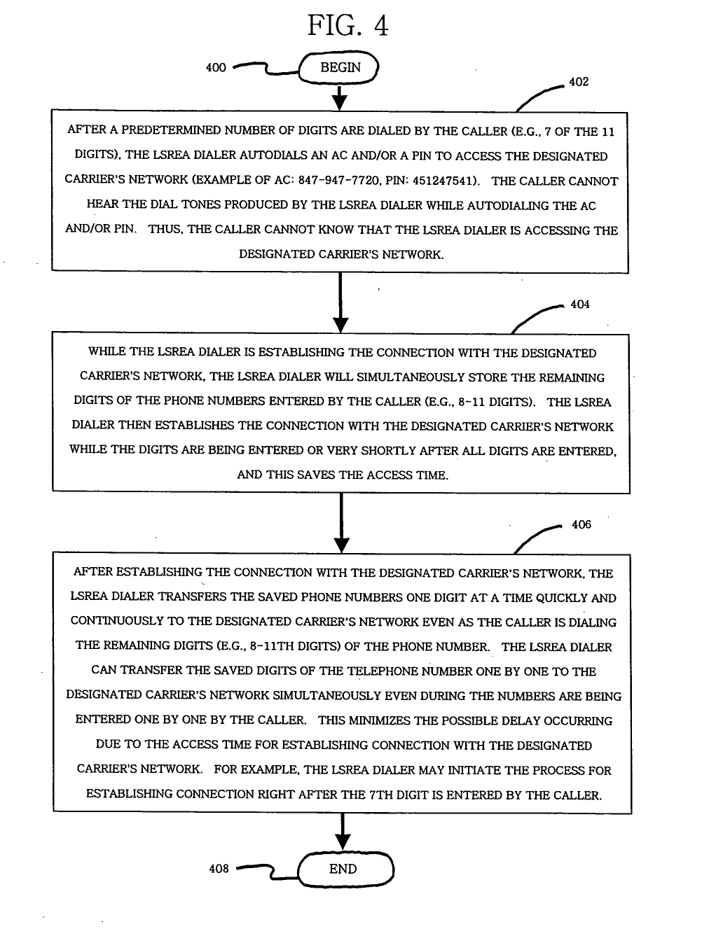

Now referring to FIG. 4, shown therein is an operational overview of the LSREA Dialer according to an embodiment of the present invention. To understand the LSREA Dialer calling process according to an embodiment of the present invention, understanding a typical telephone numbering structure in the United States would be helpful. For a telephone call within the United States, a typical telephone number is made up of 10 digits, for example, 1-847-477-7264. This telephone number consists of a three-digit “847” area code (NPA) followed by a three-digit “477” prefix (NXX), which is then followed by a four-digit “7264” telephone number according to the North American Numbering Plan (NANP).

The NANP is an integrated telephone numbering plan of 24 countries and territories: the United States and its territories, Canada, Bermuda, and 16 Caribbean nations. It is a system of three-digit area codes and seven-digit telephone numbers that direct telephone calls to particular regions on a public switched telephone network (PSTN), where they are further routed by the local network. NPA, which stands for Numbering Plan Area, is a 3-digit code that designates one of the numbering plans areas in the NANP for direct distance dialing. It is also known as area code. Prefix refers to the first set of digits of a telephone number. In the NANP countries (country code 1), it is the first three digits out of a seven-digit telephone number, which is usually called NXX. NXX is a term used for qualifying dialing digits. N stands for any number 2 through 9 and X stands for any number 0 through 9.

The local call smart routing (LCSR) is the smart routing technique of the present invention were each is categorized into a local call or a non-local call based at least on (1) the caller's telephone number or its physical location of the caller or the switch and (2) the destination telephone number or its physical location of the receiver or the receiving switch. In order to perform the above-described LCSR tasks, the telephone numbers in the targeted local service areas (such as certain or all local service areas in California or New York or Illinois) are stored in database(s) for maintaining the local telephone number records.

For example, when a caller initiates a telephone call by dialing a destination telephone number, the LSREA Dialer then categorizes the telephone call into a local call or a non-local call by comparing the dialed destination telephone number with the telephone numbers of the destination local service area kept in the record database. There could be more than 3,000 NPA-NXX numbers kept in the record database for a local service area in California or New York. Thus, in order to effectively categorize the destination telephone number into a local call or a non-local call by the LCSR, a storage medium having sufficient memory size enough to store all of the local NPA-NXX telephone numbers is needed. For example, the list of all local NPA-NXX telephone numbers organized into a data table format may be stored in a storage medium such as a DRAM or a flash memory. Once a call to a destination telephone number is categorized as a local call, the LSREA Dialer would transfer the call to the LECs' PSTN switch. On the other hand, if the destination telephone number is categorized as a non-local call, the LSREA Dialer would then transfer the call to the designated carrier's network (instead of the LEC's PSTN switch).

No matter how the LSREA Dialer routes a telephone number to different carrier's network or switches based on its own determination of local or non-local call status, all operations performed by the LSREA Dialer is performed in a manner that is almost transparent, if not completely transparent, to a caller. That is, a caller cannot readily detect or recognize that a user interface, such as the LSREA Dialer, is performing functions of determining the local or non-local call status and then routing the call through different networks or switches. If the destination telephone number is a non-local call, the LSREA Dialer will access and transfer the call to the designated carrier's network. All the processes for routing performed by the LSREA Dialer are not recognizable by callers. It is also preferable that the other devices or systems operating in association or in conjunction with the LSREA Dialer according to an embodiment of the present invention should not be recognized by the callers. In order to develop the user interface transparency, the access time should be reduced and any unnecessary additional dial tone should be eliminated so that the callers would not recognize whether the LSREA Dialer is in operation and/or even whether it is initiated or not.

Additional dial tone is the term is used for all other sounds except the dial tone and the ring tone in this invention. Examples of additional tones are sounds occurred from dialing an access code (AC) and a PIN number and sounds occurring from accessing the designated network. Access time is the time needed for the LSREA Dialer (or Auto Dialer) to establish the connection between a caller and the designated carrier's network. During the time, the LSREA Dialer dials AC (and or PIN), and get authentication. Dial tone is a telephony signal used to indicate that the telephone exchange is working and ready to accept a call. The tone stops when the first numeral is dialed, or if there is no response after going off-hook (a timeout), when it is usually followed by a special information tone.

A caller dials a telephone number prior to making any decision as to whether or not to use a LSREA Dialer. That is, to a caller, a LSREA Dialer operates in transparently in background. Thus, as long as a LSREA Dialer is set up to a caller's telephone system, the LSREA Dialer will operate and the caller need not be concerned with whether the caller should take active steps to operate the LSREA Dialer. The LSREA Dialer could be set up, for example, as a separate device connected to a caller's telephone line or equipment, or if the caller's telephone supports autodialing functions, the caller's telephone itself could be programmed to perform such functions.

An example of a typical telephone number in the United States is an eleven-digit number such as 1-999-999-####. Such telephone numbers (eleven digits or otherwise) are stored and maintained in a memory organized into an LCSR Table. TABLE 1 below shows an example of many different ways the telephone number pattern can be searched using the LCSR Table. Telephone number pattern means the value of the NPA-NXX of the caller's local telephone number, service code, and short key stored in telephone number pattern field in a LCSR Table. Telephone number pattern field is the field in a LCSR Table in which a telephone number pattern is stored.

As a caller dials each digit of the telephone number, the LSREA Dialer begins searching for each dialed digit of telephone number one by one in the LCSR Table as the caller enters each digit. That is, the LSREA Dialer does not wait for the caller to finish entering all digits of the telephone number before initiating the search. The LCSR Table organizes each telephone number based on the telephone number pattern and allows column wise searching. For example, as soon as or shortly thereafter the caller dials a first digit of “1,” only the first column of the telephone number pattern field in the LCSR Table is searched. That is, the first column of the telephone number pattern field represents the first digit a caller would dial in initiating a call. By searching the first column of the telephone number pattern field in the LCSR Table, the LSREA Dialer narrows the telephone number pattern fields to the fourth and fifth row telephone numbers in the LCSR Table (see TABLE 1).

TABLE 1
LCSR Table

| Telephone | | | | | |
|---|---|---|---|---|---|
| Number Pattern | | | | | |
| — | N | P | A | NXX | Call Type Instructions |
| 0 | 1 | 1 | | | NON-LOCAL: Transfer calls to the designated |
| | | | | | carrier's network |
| 9 | 1 | 1 | | | LOCAL: Transfer calls to the LEC's Switch |
| 4 | 1 | 1 | | | LOCAL: Transfer calls to the LEC's Switch |
| 1 | 8 | 4 | 7 | *** | LOCAL: Transfer calls to the LEC's Switch |
| 1 | 9 | 9 | 9 | 999 | LOCAL: Transfer calls to the LEC's Switch |

| | |
|---|---|
| No same | UNDETERMINABLE: Transfer calls to the |
| NPA-NXX numbers | designated carrier's network |

When a caller then dials a digit “9,” only the two rows of the telephone number pattern fields in the LCSR Table (i.e., the fourth and fifth rows) are searched. The LSREA Dialer would then further narrow the search to just the fifth row telephone number pattern field in the LCSR Table. LSREA Dialer may continue to search the third, fourth, etc. columns in the fifth row telephone number pattern field to ensure that all first seven digits (1-999-999) digits of the eleven digit telephone number match with the fifth row telephone number pattern field stored in the LCSR Table. The total number of columns to be searched is a matter of design choice. Thus, if so preferred, the LSREA Dialer of the present invention may continue to search until the last eleventh digit of the telephone number in the United States. However, the LCSR Table in an embodiment of the present invention searches only the first seven columns since it is sufficient to determine the call type of local or non-local and determine the appropriate instructions to be carried out. Adjustments can be readily made if more number of digits are needed to be searched. Thus, the LSREA Dialer can be set up to search the LCSR Table in at least the two following ways: (1) search each digit as soon as it is entered and stop when a match is found or when no match was found after searching all NPA-NXX digits of the telephone number; and/or (2) wait until all predetermined number of digits are received (for example, 7 digits) and then search the LCSR Table to find a match.

As soon as a caller dials a predetermined number (such as the first seven digits) of telephone numbers, that is, sufficient number of columns in the LCSR Table to complete the search and determine for the call type, the LSREA Dialer makes the call type decision. In other words, the LCSR Table allows the decision for the appropriate call type be made right after a caller finishes finish dialing the “NXX” part of the telephone number at the latest.

After finding all seven digits in the selected telephone number pattern field(s) in the LCSR Table, the LSREA Dialer will start to carry functions according to the instruction associated with the seven-digit telephone number pattern field(s) searched and found in the LCSR Table. In this example, the telephone number dialed is found as a local call in the LCSR Table (i.e., the fifth row).

In case no match for the dialed digits is found in the LCSR Table, then the LSREA Dialer will treat the undeterminable telephone number dialed according to a default call type, which depends on how the operator of the LSREA Dialer chooses to set up. In this example, the call type for the undeterminable telephone numbers are to be treated as non-local calls and are therefore routed to the designated carrier's network.

Now referring to FIG. 4, in case the LSREA Dialer determines that the call type for a dialed telephone number is non-local, the LSREA Dialer autodials an access code (AC) and/or a PIN number to access the designated carrier's network by beginning the act 400. A personal identification number (PIN) is a secret code shared between a user and a system that can be used to authenticate the user to the system. Typically, the user is required to provide a non-confidential user identifier or token (such as a banking card) and a confidential PIN to gain access to the system. Upon receiving the User ID and PIN, the system looks up the PIN based upon the User ID and compares the looked-up PIN with the received PIN. If they match, then the user is granted access. If they do not match, then the user is not granted access. For example, referring to the acts of 402 in FIG. 4, the LSREA Dialer may autodial “847-947-7720” as an access code and/or dial “451247541” as a PIN number. As the LSREA Dialer autodials the access code and/or the PIN number to access the designated carrier's network, the caller would not hear the dial tones. The autodialing also occurs in a short period time without causing extra delay to the caller. Thus, the autodialing operations are transparent to the caller who therefore cannot know or sufficiently determine whether a LSREA Dialer is accessing a designated carrier's network.

Then, referring to the acts 404 of FIG. 4, the LSREA Dialer through autodialing establishes the connection with the designated carrier's network. While the connection with the designated carrier's network is being established, the LSREA Dialer saves (either simultaneously or not) the remaining digits of the telephone number (for example, any of the eighth to eleventh digits) entered by the caller. In this manner, the LSREA Dialer would not introduce any extra delay to the caller for accessing the designated carrier's network. Further, the total time for accessing the designated carrier's network is reduced since the LSREA Dialer does not have to wait until the caller enters all digits of the telephone number, but instead establishes the connection with the designated carrier's network while the caller is entering the rest of the digits of the telephone number.

After the connection with the designated carrier's network is established, now referring to the acts 406 of FIG. 4, the LSREA Dialer will transfer the saved telephone number quickly and continuously one digit at a time to the designated carrier's network as the caller finishes dialing the rest of the remaining digits of the telephone number. The LSREA Dialer continues transferring the digits of the saved telephone number one by one to the designated carrier's network simultaneously as the numbers are being entered one by one by the caller. This process will minimize the delay occurred for the access time in establishing the connection with the designated carrier's network. Generally in the United States where a total of eleven digits are typically dialed as a telephone number, the LSREA Dialer would initiate the process to establish the connection with the designated carrier's network right after the last digit of a predetermined number of digits required to determine the call type (e.g., the seventh digit) is entered at the latest by the caller. The LSREA Dialer would continue to store the 8-11 remaining digits while establishing the connection with the designated carrier's network, and once the connection is made preferably even before the caller finishes entering all eleven digits of the telephone number, the LSREA Dialer will continue to quickly transfer the digits one digit at a time to the designated carrier's network even while the caller is finishing to enter all eleven digits of the telephone number. All these operations of the LSREA Dialer are to be performed transparent to the caller.

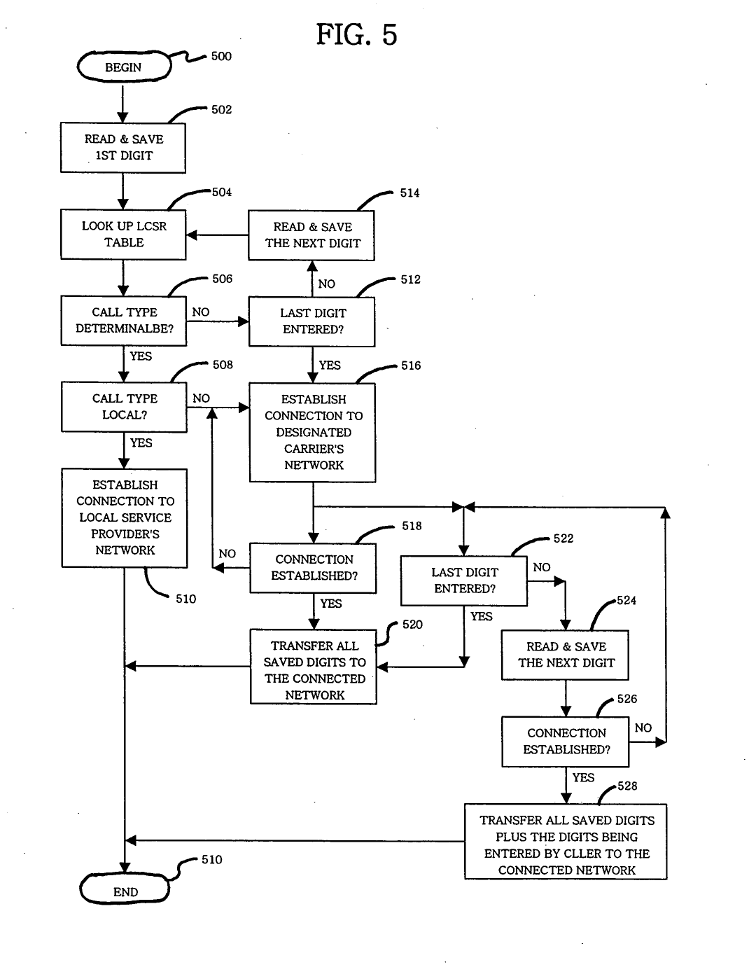

Now referring to FIG. 5, shown therein is a process flow diagram describing the operations according to an embodiment of the present invention related to the LCSR look up operations to determine the correct call type and the operations to connect to the appropriate network based on the call type determination.

In the act 500, the process would begin as a caller dials in the digits of the destination telephone number. In the act 502, the LSREA Dialer (or other appropriately similar electronic device) would read and save the first digit of the telephone number entered by the caller. The LSREA Dialer then look up the LCSR Table as already described above in detail in the act 504.

In the act of 506, attempts are made to determine the call type (such as the local or non-local call type). If the call type cannot be determined, the act 512 determines whether the last digit of the telephone number (or last digit of NXX) has been entered. If the last digit (or last digit of NXX) is determined to have been entered in the act 512, the call type is undeterminable, and thus the process flows to the act 516, in which connection to the local service provider's network will be made. If on the other hand, the last digit is not determined to be entered in the act 512, the process flows to the act 514 to continue reading and saving the next digit of the telephone number.

If in the act of 506, the call type is determined based on the number of the digits entered and saved (as discussed above, the first seven of the eleven digits of the telephone is sufficient to determine the call type in the United States), the act 508 then determines whether the call type is a local call or a non-local call.

If the call type is a local call, the act 510 establishes the connection with the local service provider's network.

If the call type is not a local call, the act 516 initiates establishing the connection to the designated carrier's network in the manner described above with respect to FIG. 4. Then, in act 518, whether or not a connection is established is checked. If connection is not established, the process flows back to the act 516 until it is completed.

While the connection is being established in the acts 516 and 518, the LSREA Dialer checks whether or not all digits of the telephone number has been entered in the act 522. If the connection is established in the act 518 by which time all digits of the telephone numbers have been entered by the caller in the act 522, this indicates an unlikely or rate situation in which the time to establish the connection with the designated carrier's network did not complete until all digits are entered by the caller. In this case, all saved digits of the telephone number are transferred to the designated carrier's network one digit at a time or other efficient method of transferring available.

The act 526 indicates that the connection is yet not established and not all digits are entered by the caller. In this case, the process flows to the act 522 to read and save the next digit in the acts 522 and 524.

If, however, the connection is established in the act 526, this indicates the most likely situation of the present invention where the connection to the designated carrier's network has been established even before the call enter all digits of the telephone number. The process then flows to the act 528, in which all save digits are transferred to the designated carrier's network either one by one or other efficient method available and all remaining digits are transferred to the designated carrier's network one digit at a time as soon as the digit is entered by the caller. Then the connection to appropriate network ends in the act 530.

As a way to save telephone costs associated with local versus non-local calls, a caller may choose to use a calling card to place telephone calls. A calling card company is a telecommunication service provider that issues calling cards allowing users to make calls through its network. Since the local telephone service providers generally provide the local calls for free or relatively low cost, the callers may not need to use a calling card to place a local call. Thus, it would be advantageous for a calling card user to place non-local calls such as the local toll calls and the long distance or international calls using the calling card and take advantage of the calling company's network instead of the local telephone service network when there are cost saving advantages.

However, whether or not a destination telephone number the caller intends to dial is a local or non-local call is not readily determinable by any telephone user such as a calling card user. It is almost impossible for any telephone user (including a calling card user) to find out beforehand receiving the telephone bill as to which telephone numbers are considered the local calls and which numbers are the considered non-local calls.

Most of the local telephone service providers define the local call for free or nominal service charge as the calls placed within a predefined local calling area. There are, for example, over 3,000 telephone numbers in one local calling area defined by a local service provider in California. Knowing just the NPA digits of the destination telephone number cannot provide the local or non-local information. A caller may need to know at least the NPA and NXX digits of the destination telephone number to get an idea of the local or non-local status.

A telephone user may be able to obtain a NPA-NXX list based on the user's location from LEC providing the telephone service. However, even if such a NPA-NXX list is obtained, the size of the list will be overwhelmingly large and will not provide any practical way for a user to effectively utilize the list to sort the destination telephone numbers by the NPA-NXX List.

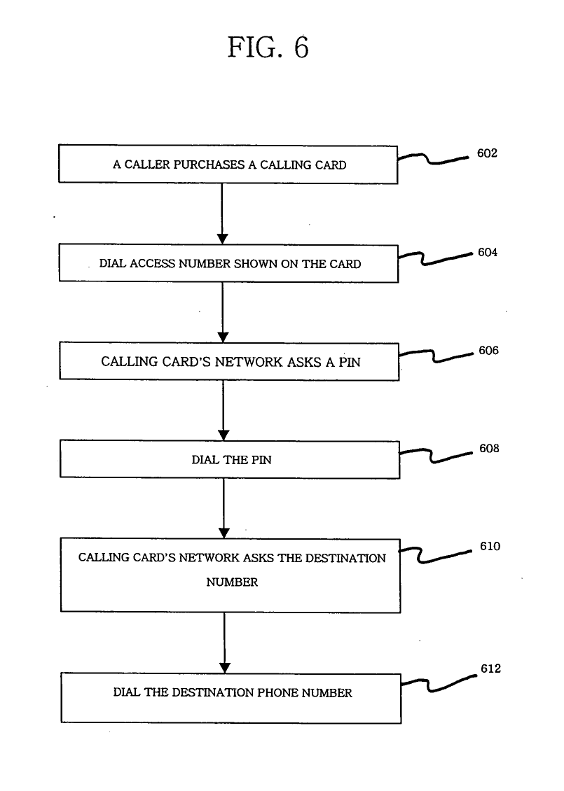

Even if a caller were able to determine that a certain destination telephone number is considered a non-local call, using a calling card is still too inconvenient to place that call. Referring to FIG. 6, a typical steps involved when placing a telephone call using a calling card is explained.

First, a caller would purchase a calling card in the step 602. Assuming that the caller has decided to use the calling card to place a call, the caller in the step 604 would dial the access number shown on the calling card, for example, 1-NPA-NXX-**** (a total of eleven digits). Access number means a telephone number to access to the designated carrier's network. Then, in step 606, the calling card company's network will ask for a PIN number, and in step 608, the caller then needs to input the PIN number, which may comprise 1-11 digits. After completing the authentication process, the calling card company's network will ask to enter the destination telephone number in the step 610. Then, the caller needs to enter the destination telephone number, for example, 1-NPA-NXX-**** (a total of eleven digits) in the step 612. This is quite impractical as a calling card user may be required to input 33 digits of numbers in order to make a single call through a calling card network.

To alleviate this problem of having to enter too many numbers in order to place a call using a calling card, a PINless calling card system is available; however, the caller is still required to input at least 22 digits to place a single call even if the call is not required to enter the PIN number.

The steps involved in placing a call using a PINless calling card is basically identical to the steps shown in FIG. 6, except that the steps 606 and 608 for entering the PIN number are not necessary. Even if the steps 606 and 608 are skipped, the caller is still expected to an access number as in the step 604 and a destination telephone number as in the step 612 to place a telephone call. Further, whether or not PINless calling card is used, the caller is still required to sort for himself whether the destination telephone number is a local or non-local call.

Further, a short key is suggested to skip the step 604 of FIG. 6 so that the caller need not dial all digits of the access code in placing a call using a calling card. To save time for dialing destination telephone numbers, callers can store the numbers on key like, “*”, “#”, “*1”, “*2” on the telephone Keypad. By pressing the short key the stored telephone number would be autodialed. However, in order to skip the step 604 of FIG. 6, the caller is required to program his designated telephone(s) such that the access number can be dialed automatically by the telephone when the caller presses the one designated key of the telephone. For example, the caller may program his telephone key “*” or “#” on the telephone keypad as the short key for dialing “1-NPA-NXX-****” (11 digits). Then, the caller may just press the designated “*” or “#” in the step 604 of FIG. 6, instead of dialing all digits of the access number to connect to the calling card company's network. However, this also provides limitations in that the caller is required to use a certain designated telephone on which he as programmed for the short key. Further, even if the step 604 of FIG. 6 can be skipped somewhat by utilizing the short key, the caller is still required to enter the PIN number and the destination telephone number. Even if the short key feature is used to reduce the number of digits need to be entered for placing a call using a calling card, the caller is still required to sort for himself the call type of the destination telephone number, i.e., a local or non-local call.

On the other hand, a user may choose use an auto dialer to access the calling card's network. Auto dialer is an electronic device that automatically dials batches of telephone numbers for connection between any two points. If the caller is placing a local call, the caller need not use the auto dialer to place a call through the local service provider's network. However, if the caller is placing a non-local call, the caller may store the access number on the auto dialer, which will then autodial the access number to connect to the calling card company's network. Nevertheless, this also is not practical as the caller is still required to sort for himself the call type of the destination telephone number, i.e., a local or non-local call.

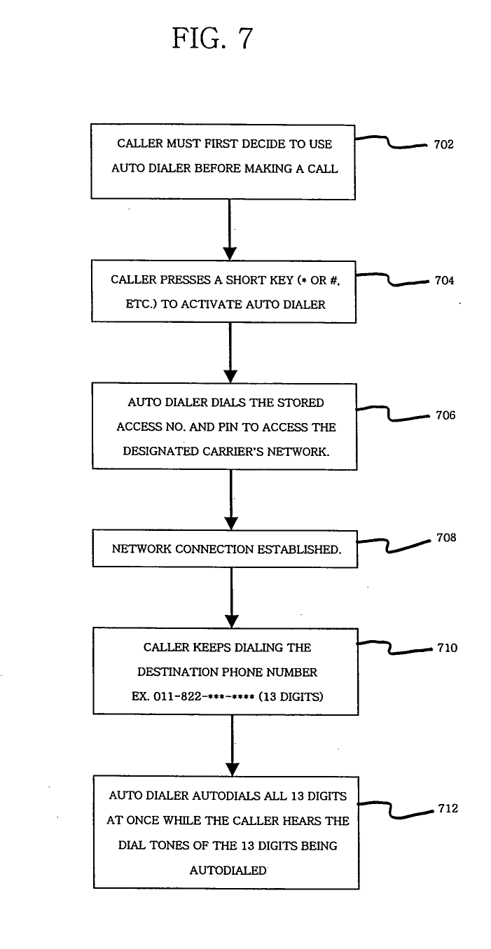

With respect to FIG. 7, it would be helpful to first understand a typical auto dialer process in the United States. An example telephone number to place an international call to Seoul, Republic of Korea from the United States could be “011-82-2-###-###.” The first three-digits of “011” would indicate that the call is an international call, the two-digit “82” is the country code for Republic of Korea, and the digit “2” indicates the city of Seoul. It has already been discussed above, but a typical telephone number in the United States, is made up of 10 digits, for example, 1-847-477-7264. This telephone number consists of a three-digit area code (NPA) followed by a three-digit prefix (NXX), which is then followed by a four-digit telephone number set according to the North American Numbering Plan (NANP).

As shown in FIG. 7, step 702, the caller must first make a decision for himself whether to use an auto dialer or not. In order to make this decision, the caller needs to know beforehand the call type of the destination telephone number since, if the caller knows that the call type is a local call, the caller need not use the auto dialer to access the network other than the local service provider's network.

If the caller intends to place an international call, the caller may readily decide that he would want to use an auto dialer, because the destination telephone number for an international call starts with 011, and this is distinctively recognizable as being a non-local call. However, if the caller intends to place a telephone call, for example, within an ambiguous distance between the caller and the receiver in the United States, determining the call type would be very difficult and impractical.

In step 704, the caller is required to enter a short key such as “*” or “#” or other to activate the auto dialer to access a designated carrier's network. Then, in step 706, the auto dialer autodials the access number and the PIN number that were stored in the auto dialer. After authentication process the connection to the designated carrier's network will be established. During these steps of dialing the access and pin numbers by the auto dialer, the additional dial tones may be heard by the caller depending on the configuration of the auto dialer.

The network connection would then be established in the step 708. Even then, the caller is required to dial by entering all digits of the destination telephone number, for example, 011-822-***-**** (13 digits) to place an international call to Seoul, Republic of Korea. After the thirteen digit telephone number is entered by the caller, the auto dialer will continuously dial the rest of the destination telephone numbers at once, and the dial tone (e.g., the DTMF Tone) would be heard or not depending on the configuration of the Auto Dialer. DTMF Tone refers to the sounds from pressing keys (1, 2, 3, 4, 5, 6, 7, 8, 9, 0, * and #) in the DTMF key pad. Dual-tone multi-frequency (DTMF) signaling is used for telephone signaling over the line in the voice-frequency band to the call switching center. The version of DTMF used for telephone tone dialing is known by the trademarked term Touch-Tone, and is standardized by ITU-T Recommendation Q.23. A different version is used for signaling internal to the telephone network.

As described above with respect to a typical auto dialer, it is almost impossible for a typical auto dialer or a caller to simply find out beforehand the non-local call types, unless the destination telephone number is a readily recognizable telephone number like an international telephone number. The typical auto dialer process is not transparent to a caller as it produces unnecessary additional dial tones heard by the caller and requires extra the access time.

In summary, the four techniques available in the telecommunication field as described above still present many problems to telephone users who wish to save telephone usage cost by effectively routing non-local calls, which are not provided free of charge. One of the biggest drawbacks of the four techniques described above is that the caller is expected to know the call type of the destination telephone number (local or non-local). Even though a listing of NPA-LXX telephone numbers in a local calling area may be available to a telephone user, using such a lengthy listing would be almost impossible and impractical for ordinary calling uses. The callers would run out of time and patience to compare the destination telephone number with the over 3,000 NPA-NXX telephone numbers on the listing.

Even though each of the four techniques above offers skipping of some step or steps in accessing the designated network, all of these techniques still require more time to establish the connection to the network, because of the authentication process and the additional dialing process are still needed.

In contradistinction, the LSREA Dialer in accordance with an embodiment of the present invention overcomes all shortfalls present in the above four and other telephone calling techniques and provides significant advantages. As already discussed above, a LCSR Table is maintained according to the present invention, and the LSREA Dialer performs the telephone network determining and accessing operations transparently such that a telephone user would not recognize them.

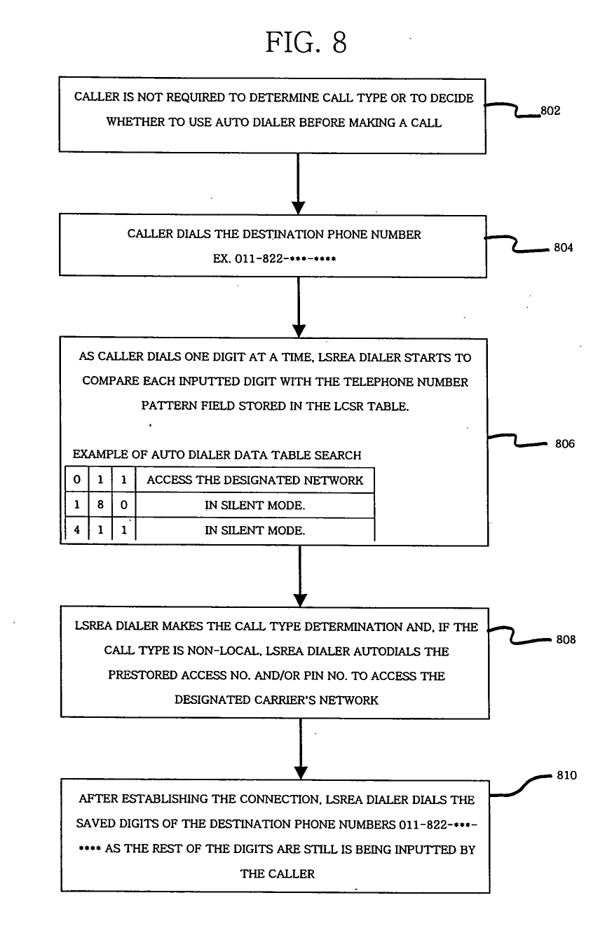

Now referring to FIG. 8, a caller is not required to determine call type or to decide whether to use auto dialer before making a call as in the act 802. Unlike the auto dialer example as explained above with respect to FIG. 7, the decision to use the LSREA Dialer to connect to a non-local designated carrier's network will be made by the embedded database in the LSREA Dialer.

Then the caller dials the destination telephone number as in the act 804 without being concerned with the access number or a PIN number required to access a particular carrier's network for a non-local calls. In the example shown in FIG. 8, act 804, a caller would be dialing a destination telephone number 1-NPA-NXX-**** having a total of 13 digits to place an international call to Seoul, Republic of Korea. Then, in act 806, the LSREA Dialer starts to compare each inputted digit with the telephone number pattern field stored in the LCSR Table as the caller continues to dial one digit at a time. That is, NPA-NXX part of the destination telephone numbers are compared one by one as the digits are inputted with the NPA-NXX stored in the telephone number pattern field of LCSR Table. The operations of determining the telephone number pattern field using a LCSR Table have already been described in detail above.

The LSREA Dialer then makes a call type determination as in the act 808. If the destination telephone number is determined to be a local call type (i.e., the same NPA-NXX of the destination telephone numbers are found in telephone number pattern field in the LCSR Table), the LSREA Dialer will establish a connection to a local service provider's network (such as a LEC's network) and transfer the destination telephone number to the LEC's switch.

If the call type is determined to be non-local, the LSREA Dialer will autodial the prestored access number and/or the PIN number to access the designated carrier's network as in the act 808. If the destination telephone number is determined to a non-local call (namely the same NPA-NXX of the destination telephone numbers are not found in the telephone number pattern field in the LCSR Table), the LSREA Dialer dials the access number and/or the PIN number transparently to the caller to access the designated carrier's network to transfer the destination telephone numbers.

Then in act 810, the LSREA Dialer will preferably finish establishing the connection to the designated carrier's network even before all 13 digits are entered by the caller. After establishing the connection, the Lsrea Dialer dials the already saved digits of the destination phone numbers 011-822-***-**** even as the rest of the digits are still is being inputted by the caller.

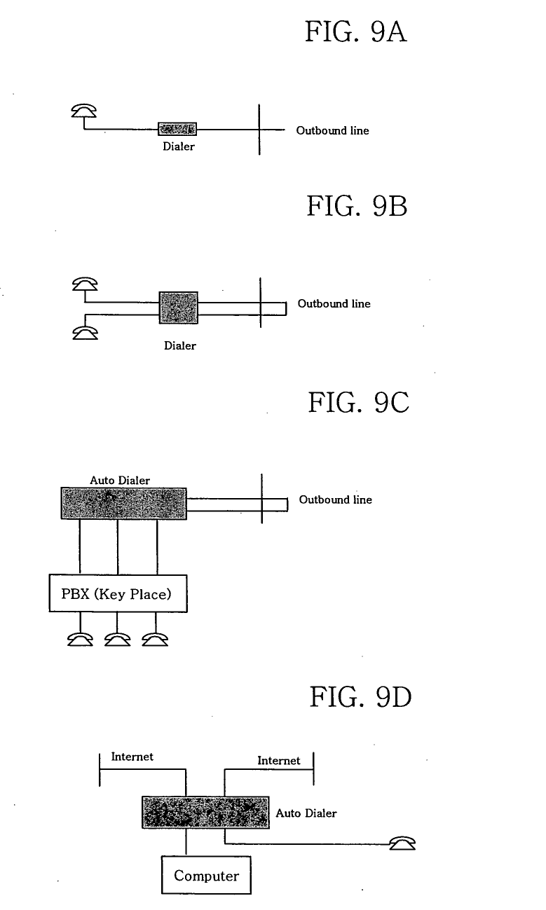

Now referring to FIGS. 9A-9D, shown therein are four, among many, different configurations for a LSREA Dialer for installation on the caller-side telephone system. As shown in FIG. 9A, the LSREA Dialer can be installed on a single telephone line in series with the telephone. As shown in FIG. 9B, multiple telephone lines can be connected to the single LSREA Dialer. Yet further, referring to FIG. 9C, a PBX system can be connected to a LSREA Dialer. A LSREA Dialer can be located in between a PBX and the outbound telephone lines or PBX and inside telephone lines. Still in FIG. 9D, connection can be made between a digital telecommunication device such as a DSL modem and a LSREA Dialer.

Many other different installations and configurations for the LSREA Dialer are possible depending on the caller's environment and needs. Regardless of the caller's environment and various needs, as long as the LSREA Dialer is located between the outbound telephone line(s) and telephone(s), the capability and functionality of the LSREA Dialer and transparent user interface will be same.

There are at least three main components in a LCSR Table. The telephone number pattern field in a LCSR Table has a listing of NPA-NXX local telephone numbers. The instruction field of the LCSR Table has all instruction(s) for initiating the LSREA Dialer process associated with each one or group of phone number pattern fields in the LCSR Table. The database maps a telephone number pattern field to an appropriate instruction field.

A LCSR Table may store therein the short keys to easily dial a predetermined number, for example, an access telephone number. To dial an access number easily, a user may associate a certain key(s) in telephone keypad with the access number and storing the access number in the LCSR Table. For example, a user can choose to associate “*” or “#” or “*1” or “*2” with the digits of the access telephone number and store the short key(s) in the LCSR Table.

A LCSR Table may store therein the international dialing prefix (IDP), which is currently “011.” As such, the LSREA Dialer can be set up in the LCSR Table to all transfer all IDP calls to a designated carrier's network.

A LCSR Table may store therein the circuit identification code (CIC), easily recognizable code (ERC), and the service code that are associated with the instructions to transfer the destination telephone numbers to a local service provider's switch (i.e., a LEC's switch).

Circuit Identification Code (CIC) in the Initial Address Message (IAM) consists of a range of 0 to 65,535. On the signaling path the CIC provides information about where the voice part of the call is carried-on which trunk and in which time slot. An easily-recognizable code (ERC), in the NANP, is any area code that end in double digits, such as 800, 877, 900, and 700. A service code or VSC is a special telephone number that usually begins with the * (star) key on a touchtone keypad. Most codes are two digits, although those starting with 2 or 3 are now usually three digits. Some cellular telephone companies also use # instead of *, though this is actually just a short number typically used for other commercial services (e.g. pizza delivery), and not a VSC for accessing telephone company services.

A LCSR Table may store therein the NPA-NXX telephone numbers. To sort a destination telephone number into a local call or a non-local call, all of the NPA-NXX numbers of the telephone numbers in a give local calling area are stored in the LCSR Table. All of the NPA-NXX numbers could be stored by in different units or geographic scale like per the local calling area or the LATA or the states or nationwide.

Hereinbelow, the process for placing calls utilizing a LCSR Table are described as an overview with respect to another LCRS Table 2 of TABLE 2 as shown below. In the TABLE 2, five short keys “*”, “*1”, “*n”, and “**” are stored as the first five rows of the phone number pattern field. To each short key pattern field, an instruction field is associated with.

As a first step, the destination telephone number is received from a caller. The destination telephone number inputted by the caller could contain various information such as CIC, service code, ERC, NII, etc.

The following second to fifth steps should be performed while the first step above is still in progress. In the second step, as the digits of the destination telephone number are being entered, the LCSR Table 2 is searched to find the same digit in the first, second, third, etc. columns in the telephone number pattern field. Each digit of the dialed telephone number will be searched and compared with the data in the LCSR Table 2 in the order of dial entry.

If the dialed number is a short key, for example “#”, the LCSR Table 2 is searched to find the same value in the first row in the first column in the LCSR Table 2 below (see TABLE 2). The search in the LCSR Table 2 will then stop since there is no need to search any further than the first row. The association field associated with the first telephone number pattern field is to transfer the calls to the designated carrier's network. The LSREA Dialer will then be instructed to establish a connection with the designated carrier's network.

If the dialed number is a CIC, service code, IDP, or NII, for example “911”, the LCSR Table 2 is searched to find the same value in the seventh row in the LCSR Table 2 below. Since the matching telephone number pattern field is found, the search in the LCSR Table 2 stops. Then the LSREA Dialer is instructed to connect to the LECs switch according to the instruction field in the seventh row of the LCRS Table 2.

If the dialed number is a typical telephone number such as “1-847-947-7720,” the LCSR Table 2 is searched to find the same value in the eleventh row in the LCSR Table 2 below. After finding the pattern field in the eleventh row, the search in the LCSR Table 2 stops. The LSREA Dialer to then instructed connect to the LEC's switch according to the eleventh row instruction field.

TABLE 2
LCRS Table 2

| Phone Number Pattern | | | | | | | Instruction Field |
|---|---|---|---|---|---|---|---|
| # | | | | | | | Transfer the calls to the designated |
| | | | | | | | carrier's network |
| * | | | | | | | Transfer the calls to the designated |
| | | | | | | | carrier's network |
| * | 1 | | | | | | Transfer the calls to the designated |
| | | | | | | | carrier's network |
| * | n | | | | | | Transfer the calls to the designated |
| | | | | | | | carrier's network |
| * | * | | | | | | Transfer the calls to the designated |
| | | | | | | | carrier's network |
| 4 | 1 | 1 | | | | | Transfer calls to the LEC's Switch |
| 9 | 1 | 1 | | | | | Transfer calls to the LEC's Switch |
| 1 | 0 | 1 | 0 | | | | Transfer calls to the LEC's Switch |
| 1 | 8 | 0 | 0 | | | | Transfer calls to the LEC's Switch |
| 0 | 1 | 1 | | | | | Transfer the calls to the designated |
| | | | | | | | carrier's network |
| 1 | 8 | 4 | 7 | 9 | 4 | 7 | Transfer the calls to the LEC's switch |

| | |
|---|---|
| No matching numbers | Transfer calls to the designated |
| | carrier's switch |

Third, the search in the LCSR Table 2 continues until the same value for the dialed digits is found in the telephone number pattern field in the LCSR Table 2. The search in the LCSR Table 2 stops when the same value is found in the telephone number pattern field. The instruction field associated with the found telephone number pattern field determines whether to transfer a call or establish a connection with the designated carrier's or LEC's network.

Fourth, based on the instruction field associated with the telephone number pattern field in the LCSR Table 2, the LSREA Dialer initiates a step to transfer a call or establish a connection with the designated carrier's or LEC's network. For local calls, the LSREA Dialer transfers the calls to the LEC's switch. For non-local calls, the LSREA Dialer transfers the calls to the designated carrier's network. In case of no matching value is found, then LSREA Dialer will transfer the numbers to the designated network, which could be predefined by the operator of the LSREA to be either a local service provider's network (treating the non-matching numbers as having the call type of a local call) or to a designated carrier's network (treating the non-matching numbers as having the call type of a non-local call). In the case of the LCSR Table 2, telephone numbers for which a match cannot be found in the LCRS Table 2 are treated as a non-local call type; thus, the call will be switched to the designated carrier's network.

The call type can be determined by searching the LCSR Table before the callers finish dialing all digits of the destination telephone numbers. If the call type of the telephone number is determined to be a non-local call, then the LSREA Dialer dials the appropriate access code and/or the PIN number to establish the connection to the designated carrier's network. However, the callers do not hear any additional dial tone during the access time. Once the connection is established, the LSREA Dialer sends out the saved whole destination number without any additional DTMF Tone in order to give the same environment to the caller. In any case, errors found then the connection will be disconnected immediately.

If a destination telephone number is a non-local call, the LSREA Dialer will access the designated carrier's network and transfer the call, and all these processes involved in connecting to the designated carrier's network should not be readily recognized by callers. To do so, the LSREA Dialer minimizes the accessing time and eliminates any additional dial tone so that callers do not recognize whether LSREA Dialer is working or not. The LSREA Dialer is initiated as quickly as possible to save time for establishing the connection with the designated carrier's network. For example, instead of waiting for all digits of the telephone number are entered, the call type can be determined by searching the LCSR Table at a point no later than when the caller inputs NXX of the destination telephone number.

If the destination telephone number is a local call, then the LSREA Dialer transfers the destination telephone number to LEC's switch. In this case, caller may hear only one DTMF Tone, Dial Tone, and Ring Tone. If the destination telephone number is a non-local call, then the LSREA Dialer transfers the destination telephone number to the designated carrier's network. In this case, the LSREA Dialer mutes any additional dial tone so that callers can only hear one DTMF Tone, Dial Tone, and Ring Tone. In this manner, the caller does not readily recognize that the LSREA Dialer is establishing a connection to a different network that is not same as the local calling service provider's network.

Ring tone is the sound made by a telephone to indicate an incoming call. The term, however, is most often used to refer to the customizable sounds available on mobile telephones. This facility was originally provided so that people would be able to determine when their telephone was ringing when in the company of other mobile telephone owners.

To initiate the LSREA Dialer, telephone number should be entered, and then the telephone number is sorted by searching the LCSR Table, and then the instruction to control the LSREA Dialer is found in the LCSR Table. After comparing the telephone number with the value in the telephone Pattern Field in the LCSR Table, LSREA Dialer can determine the call type.

If the destination telephone number is the non-local call, then the LSREA Dialer transfers the destination telephone number to the designated carrier's network. In this case, the LSREA Dialer mutes the any additional dial tone so that callers can hear only one DTMF tone, dial tone, and ring tone same as the local call case.

Described hereinbelow is another example for the LSREA Dialer having the LCSR Table 3 (TABLE 3) in accordance with an embodiment of the present invention.

TABLE 3
LCSR Table 3

| Phone Number Pattern | | | | | | | Instruction |
|---|---|---|---|---|---|---|---|
| # | | | | | | | Transfer the calls to the designated |
| | | | | | | | carrier's network |
| * | | | | | | | Transfer the calls to the designated |
| | | | | | | | carrier's network |
| 9 | 1 | 1 | | | | | Transfer the calls to the LEC's Switch |
| 1 | 0 | 1 | 0 | | | | Transfer the calls to the designated |
| | | | | | | | carrier's network |
| 1 | 7 | 3 | 5 | . | . | . | Transfer calls to the LEC's Switch |
| 1 | 7 | 4 | 1 | . | . | . | Transfer calls to the LEC's Switch |
| 1 | 7 | 4 | 2 | 8 | 3 | . | Transfer calls to the LEC's Switch |
| 1 | 7 | 4 | 2 | 8 | 4 | 7 | Transfer calls to the LEC's Switch |
| 1 | 7 | 4 | 3 | 0 | . | . | Transfer calls to the LEC's Switch |
| 1 | 7 | 5 | 5 | 1 | . | . | Transfer calls to the LEC's Switch |
| 1 | 8 | . | . | . | . | . | Transfer calls to the LEC's Switch |

A caller dials a destination telephone number such as 1-742-847-7720, and to the caller a decision about whether use the LSREA Dialer or not is a non-issue.

As soon as the caller dials the first digit “1”, LCSR Table 3 immediately searched to find the same digit of “1” in the first column of every telephone number pattern field in the LCSR Table 3. Then, the fourth to eleventh rows of the LCSR Table 3 are identified to have “1” in the first column of the number pattern field.

As soon as the caller dials the second digit “7”, only the 4th to 11th rows of the telephone number pattern field in the LCSR Table 3 is immediately searched again to find the same digit of “7” in the second column. Then, the fifth to tenth rows of the LCSR Table 3 are identified to have “17” in the first and second columns of the number pattern field.

As soon as the caller dials the third digit “4”, only the 5th to 10th rows of the telephone number pattern field in the LCSR Table 3 is immediately searched again to find the same digit of “4” in the third column. Then, the sixth to ninth rows of the LCSR Table 3 are identified to have “174” in the first to third columns of the number pattern field.

As soon as the caller dials the fourth digit “2”, only the 6th to 9th rows of the telephone number pattern field in the LCSR Table 3 are immediately searched again to find the same digit of “2” in the fourth column. Then, the seventh to eighth rows of the LCSR Table 3 are identified to have “1742” in the first to fourth columns of the number pattern field.

As soon as the caller dials the fifth digit “8”, only the 7th to 8th rows of the telephone number pattern field in the LCSR Table 3 are immediately searched again to find the same digit of “8” in the fifth column. Then, the seventh to eighth rows of the LCSR Table 3 are identified to have “17428” in the first to fifth columns of the number pattern field.

As soon as the caller dials the sixth digit “4”, only the 7th to 8th rows of the telephone number pattern field in the LCSR Table 3 are immediately searched again to find the same digit of “4” in the sixth column. Then, the eighth row of the LCSR Table 3 is finally identified to have “174284” in the first to sixth columns of the number pattern field.

Then, the search in the LCSR Table 3 stops since a match was found. The LSREA Dialer is then initiated immediately to establish connection to an appropriate telephone network according to the instruction field of the eighth row of the LCSR Table 3 (that is, to transfer the call to a LEC's switch). In this example, the call type is a local call, and the LSREA Dialer thus transfers the call to the LEC's switch.

Described hereinbelow is another example for the LSREA Dialer having the LCSR Table 4 (TABLE 4) to illustrate how a non-local call is routed in accordance with an embodiment of the present invention.

TABLE 4
LCSR Table 4

| Phone Number Pattern | | | | | | | Instruction |
|---|---|---|---|---|---|---|---|
| # | | | | | | | Transfer the calls to the designated |
| | | | | | | | carrier's network |
| * | | | | | | | Transfer the calls to the designated |
| | | | | | | | carrier's network |
| 9 | 1 | 1 | | | | | Transfer the calls to the designated |
| | | | | | | | carrier's network |
| 1 | 0 | 1 | 0 | | | | Transfer the calls to the designated |
| | | | | | | | carrier's network |
| 1 | 7 | 3 | 5 | . | . | . | Transfer calls to the LEC's Switch |
| 1 | 7 | 4 | 1 | . | . | . | Transfer calls to the LEC's Switch |
| 1 | 7 | 4 | 2 | 6 | 3 | . | Transfer calls to the LEC's Switch |
| 1 | 7 | 4 | 2 | 9 | 4 | 7 | Transfer calls to the LEC's Switch |
| 1 | 7 | 4 | 3 | 0 | . | . | Transfer calls to the LEC's Switch |
| 1 | 7 | 5 | 4 | 1 | . | . | Transfer calls to the LEC's Switch |
| 1 | 8 | . | . | . | . | . | Transfer calls to the LEC's Switch |

| | |
|---|---|
| No matching pattern | Transfer the call to the designated |
| | carrier's network |

A caller dials a destination telephone number such as 1-745-847-7720 without taking consideration of whether the LSREA Dialer is to be used or not. The LSREA Dialer works in the background substantially transparent to the caller to route the calls in cost effective way.

As soon as the caller dials the first digit “1”, LCSR Table 4 immediately searched to find the same digit of “1” in the first column of every telephone number pattern field in the LCSR Table 4. Then, the fourth to eleventh rows of the LCSR Table 4 are identified to have “1” in the first column of the number pattern field.

As soon as the caller dials the second digit “7”, only the 4th to 11th rows of the telephone number pattern field in the LCSR Table 4 is immediately searched again to find the same digit of “7” in the second column. Then, the fifth to tenth rows of the LCSR Table 4 are identified to have “17” in the first and second columns of the number pattern field.

As soon as the caller dials the third digit “4”, only the 5th to 10th rows of the telephone number pattern field in the LCSR Table 4 is immediately searched again to find the same digit of “4” in the third column. Then, the sixth to ninth rows of the LCSR Table 3 are identified to have “173” in the first to third columns of the number pattern field.

As soon as the caller dials the fourth digit “5”, only the 6th to 9th rows of the telephone number pattern field in the LCSR Table 4 are immediately searched again to find the same digit of “5” in the fourth column. No matching telephone number pattern field is found since no fifth column of the 6th to 9th rows contain “5”.

The search in the LCSR Table 4 stops since no match was found. When no match is found as in this situation, the LSREA Dialer can be designed so that the call type would default to a predetermined one of local or non-local calls. In this example with respect to LCSR Table 4, the call type for a non-matching telephone number is a non-local call. Thus, the LSREA Dialer would initiate establishing connection with a designated carrier's network.

It is noted that the LSREA Dialer continues to receive and save the digits of the dialed telephone number as the LSREA Dialer is establishing a connection to a network of choice transparently to the caller. Once the connection to the network of choice is established, the LSREA Dialer would transfer all digits of the dialed telephone numbers to the connected network as quickly as possible and all additional digits inputted after establishing the connection are also transferred to the connected network as soon as those additional digits are dialed by the caller and received by the LSREA Dialer.

The LSREA Dialer according to an embodiment of the present invention provides many significant advantages over the types of telephone services including a typical auto dialer process. According to the present invention, it is the LSREA Dialer with LCSR Table who makes the decision regarding the choice of the carrier's network, and this decision process by the LSREA Dialer is unrecognizable by a caller. However, in a typical auto dialer process, the caller is required to make the decision as to what would be telephone network of choice even before dialing the telephone number.

Further, the LSREA Dialer can make a decision as to the preferred network of choice any time during the caller is dialing the digits of the telephone number. For example, the LSREA Dialer is capable of making the decision no later than the NXX is entered. However, in a typical auto dialer process, the caller is required to make the decision as to what would be telephone network of choice even before dialing the telephone number.

The point at which time the LSREA Dialer can initiate the connection to a preferred telephone network can be initiated is earlier than a typical auto dialer. As already described above in numerous instances, the LSREA Dialer utilizing a LCSR Table can initiate connection to network process as soon as it determines the call type on its own. While a caller is still dialing the destination telephone numbers, the LSREA Dialer can establish the connection even before the caller finish the dialing all digits of the destination telephone number. This is just not possible for a typical auto dialer.

As described above on numerous instances, the LSREA Dialer transfers the destination telephone number to LECs switch if it has determined that the call type of the destination telephone number is a local call. In this case, the caller can hear only one DTMF tone, dial tone, and ring tone, which is audible for all local call connections. If the call type of the destination telephone number is a non-local call, then the LSREA Dialer transfers the destination telephone number to the designated carrier's network. In such a case, however, the LSREA Dialer mutes any additional dial tone so that callers can only hear one DTMF Tone, dial tone, and ring tone same as the local call case. In this manner, callers do not readily recognize that the LSREA Dialer is operating to establish connection to a different telephone network.

By utilizing the LSREA Dialer according to the present invention, the cost for setting up the gateways and switches can be saved. A gateway in this application refers to an equipment to transfer calls from PSTN network to VoIP network or vice versa.

Compared to a typical auto dialer, the LSREA Dialer can distinguish a local call from a non-local call. And the LSREA Dialer can send only the non-local call to the designated carrier's network. However, a typical auto dialer cannot clearly distinguish the local calls from the non-local calls, and a typical auto dialer, sometimes, may accidentally transfer some of the local calls to a designated carrier's network that is not same as the local calling service provider's network. Therefore, if the caller uses a typical auto dialer, the designated carrier needs more switches (or gateways) to receive the some of the local calls, which are accidentally transferred. However, by using the LSREA Dialer, the designated carrier can save some by not needing those additional switches (or gateways), because the LSREA Dialer will avoid making the mistakes of delivering local call to the gateways.

The LSREA Dialer allows a carrier to pass the savings to the callers. Since the designated carriers can save some cost to deliver the calls by utilizing the LSREA Dialer, they would be able to provide lower priced telephone services to telephone service consumers.

The LSREA Dialer save the connection time as opposed to a typical auto dialer or other conventional devices for reasons already described above on numerous instances.

Any additional dial tones that are not a part of local calling process are not heard by a caller so that the caller does not know whether or not the caller is using the LSREA Dialer while making the calls.

It will be clear that the present invention is well adapted to attain the ends and advantages mentioned as well as those inherent therein. While a various embodiments including the presently preferred one has been described for purposes of this disclosure, various changes and modifications may be made, which are well within the scope of the present invention. Numerous other changes may be made which will readily suggest themselves to those skilled in the art and which are encompassed in the spirit of the invention disclosed and as defined in the appended claims.

What is claimed is:

1. A method of routing a telephone connection to either a local calling service provider's network or a designated carrier's network, the method comprising:
receiving and storing each digit of a telephone number as the digits are dialed by a user;
while each digit is being received, determining whether the telephone number is inside a predetermined calling area based on the number of digits received;
when the telephone number is determined as not being inside a predetermined calling area, establishing connection to a designated carrier's network even during each digit is being received; and
when the telephone number is determined as being inside a predetermined calling area, establishing connection to a local calling service provider's network.

2. The method of claim 1, wherein the act of establishing connection to a designated carrier's network even during each digit is being received and saved is performed transparently to the user without producing substantially audible sound including at least dial tone or DTMF tone to the user.

3. The method of claim 1, wherein the predetermined calling area is adjustable based on one of at least:
a local calling area;
LATA;
a plurality of telephone numbers in one or more states in the United States; and
all telephone number in the United States.

4. The method of claim 3, wherein the act of determining whether the telephone number is inside a predetermined calling area based on the already received number of digits even during each digit is being received comprises the acts of:
maintaining a searchable database comprising:
a plurality of telephone number pattern fields corresponding to a plurality of telephone numbers in a predetermined calling area; and
a plurality of instruction fields, at least one of which instruction field is associated with each telephone number field; and
searching the searchable data base one digit at a time sequentially for one or more number of received digits until a telephone number pattern field matching the one or more number of received digits are found in the plurality of telephone number pattern fields, unless all digits of a telephone number dialed by the user have been searched in the searchable database.

5. The method of claim 4, wherein, when no matching telephone pattern field is found in the searchable database after searching all digits of a telephone number dialed by the user, the telephone dialed by the user is connected to a predetermined network of either a local calling service provider or a designated carrier.

6. The method of claim 5, wherein, when no matching telephone pattern field is found in the searchable database after searching all digits of a telephone number dialed by the user, the telephone number is associated with a default instruction field predefined in the searchable database such that the default instruction field contain decision for connecting to either the local service provider's network or the designated carrier's network.

7. The method of claim 4 further comprising, when a matching telephone pattern field matching the one or more number of received digits is found in the searchable database, determining whether the telephone number dialed by the user is inside or outside a predetermined calling area based on the instruction field associated with the matching telephone number pattern field.

8. The method of claim 7, wherein the act of establishing connection to a designated carrier's network even during each digit is being received and the act of establishing connection to a local calling service provider's network are performed transparently to the user without producing substantially audible sound including at least dial tone or DTMF tone to the user.

9. The method of claim 7, wherein the act of establishing connection to a designated carrier's network comprises autodialing a number of digits required by the designated carrier for connection to the designated carrier's network.

10. The method of claim 9, wherein a number of digits required by the designated carrier for connection to the designated carrier's network comprise one or both of an access number and a PIN number, and wherein the autodialing of one or both of the access number or the PIN number occur without producing substantially audible sound including at least dial tone or DTMF tone to the user.

11. The method of claim 10, further comprising the act of transferring all received digits of the telephone number dialed by the user after establishing the connection with the designated carrier's network and transferring any additional digits dialed by the user after having established the connection with the designated carrier's network without producing substantially audible sound including at least dial tone or DTMF tone to the user.

12. The method of claim 4, wherein the telephone number pattern field of the searchable database comprise one or more number of digits representing one of at least:
a short key;
an access number;
a PIN number;
an international dialing prefix (IDP);
a circuit identification code (CIC);
a service code;
NPA-NXX of a telephone number in the predetermined calling area.

13. A smart autodialer for routing a telephone connection to either a local calling service provider's network or a designated carrier's network, the method comprising:
a first port connectable to a telecommunication device including a telephone;
a second port connectable to a outside telephone network;
a storage unit receiving and storing each digit of a telephone number as the digits are dialed by a user and inputted to the first port;
a process unit for determining whether the telephone number being dialed by the user is inside a predetermined calling area based on the number of digits received;
wherein, when the telephone number is determined as not being inside a predetermined calling area, connection to a designated carrier's network is established even during each digit is being received; and
wherein, when the telephone number is determined as being inside a predetermined calling area, connection to a local calling service provider's network is established.

14. The smart autodialer of claim 13, wherein the connection is established to a designated carrier's network even during each digit is being received and saved is performed transparently to the user without producing substantially audible sound including at least dial tone or DTMF tone to the user.

15. The smart autodialer of claim 13, wherein the predetermined calling area is adjustable based on one of at least:
a local calling area;
LATA;
a plurality of telephone numbers in one or more states in the United States; and
all telephone number in the United States.

16. The smart autodialer of claim 15 further comprising a searchable database comprising:
a plurality of telephone number pattern fields corresponding to a plurality of telephone numbers in a predetermined calling area; and
a plurality of instruction fields, at least one of which instruction field is associated with each telephone number field;
wherein the searchable data base is searched one digit at a time sequentially for one or more number of received digits until a telephone number pattern field matching the one or more number of received digits are found in the plurality of telephone number pattern fields, unless all digits of a telephone number dialed by the user have been searched in the searchable database.

17. The smart autodialer of claim 16, wherein, when no matching telephone pattern field is found in the searchable database after searching all digits of a telephone number dialed by the user, the telephone dialed by the user is connected to a predetermined network of either a local calling service provider or a designated carrier.

18. The smart autodialer of claim 17, wherein, when no matching telephone pattern field is found in the searchable database after searching all digits of a telephone number dialed by the user, the telephone number is associated with a default instruction field predefined in the searchable database such that the default instruction field contain decision for connecting to either the local service provider's network or the designated carrier's network.

19. The smart autodialer of claim 16, wherein, when a matching telephone pattern field matching the one or more number of received digits is found in the searchable database, whether the telephone number dialed by the user is inside or outside a predetermined calling area is determined based on the instruction field associated with the matching telephone number pattern field.

20. The smart autodialer of claim 19, wherein the connection to a designated carrier's network is established even during each digit is being received and the act of establishing connection to a local calling service provider's network are performed transparently to the user without producing substantially audible sound including at least dial tone or DTMF tone to the user.

21. The smart autodialer of claim 19, wherein the connection to a designated carrier's network is established by autodialing a number of digits required by the designated carrier for connection to the designated carrier's network.

22. The smart autodialer of claim 21, wherein a number of digits required by the designated carrier for connection to the designated carrier's network comprise one or both of an access number and a PIN number, and wherein the autodialing of one or both of the access number or the PIN number occur without producing substantially audible sound including at least dial tone or DTMF tone to the user.

23. The smart autodialer of claim 22, wherein all received digits of the telephone number dialed by the user are transferred after establishing the connection with the designated carrier's network and any additional digits dialed by the user after having established the connection with the designated carrier's network are also transferred without producing substantially audible sound including at least dial tone or DTMF tone to the user.

24. The smart autodialer of claim 16, wherein the telephone number pattern field of the searchable database comprise one or more number of digits representing one of at least:
a short key;
an access number;
a PIN number;
an international dialing prefix (IDP);
a circuit identification code (CIC);
a service code;
NPA-NXX of a telephone number in the predetermined calling area.
